(19) United States
(12) Patent Application Publication
(10) Pub. No.: US 2021/0084716 A1
(43) Pub. Date: Mar. 18, 2021

(54) A SYSTEM FOR INITIATING A DE-ICING OR A DE-FOGGING FORMED ON A SUBSTRATE MATERIAL

(71) Applicant: AGC GLASS EUROPE, Louvain-la-Neuve (BE)

(72) Inventors: Yannick SARTENAER, Vedrin (BE); François BOLAND, Gembloux (BE); Quentin FRASELLE, Mont Saint Guibert (BE); Thomas LAMBRICHT, Perwez (BE); Etienne ALEXIS, Vedrin (BE)

(73) Assignee: AGC GLASS EUROPE, Louvain-la-Neuve (BE)

(21) Appl. No.: 17/041,335

(22) PCT Filed: Mar. 29, 2019
(86) PCT No.: PCT/EP2019/058099

§ 371 Date: Sep. 24, 2020

(30) Foreign Application Priority Data
Mar. 29, 2018 (EP) 18164836.1

(51) Int. Cl. H05B 1/02; G02B 27/00; B60S 1/02; H05B 3/86

(52) U.S. Cl. CPC H05B 1/0236; H05B 3/86; B60S 1/026; G02B 27/0006

(57) ABSTRACT

A system for initiating a de-icing or de-fogging action on which ice has formed on a substrate material. The system includes (a) a substrate on which ice or fog has formed; and, (b) irradiation producing devices operative to emit irradiation that passes through at least some portion of the substrate so that a first portion of the ice or fog that is impacted by the irradiation is an interfacial portion nearest a surface of the substrate, the devices being proximate the substrate material, and selectively activated to effect irradiation, causing melting of at least some ice nearest the surface of the substrate. The substrate has an absorption coefficient lower than 15 m⁻¹ in the wavelength range from 750 to 1650 nm.

This invention relates to a specific way of using narrowband infrared irradiation to de-ice or de-fog or release ice or fog/water from a surface. Particularly, this invention relates to a way of using narrowband irradiation to de-ice or release ice or water from a surface of a glass substrate or a plastic substrate. More particularly, the invention relates a specific way of using narrowband irradiation to de-ice or release ice from a surface intercepting the field of view (FOV) of optical sensors.

Some traditional de-icing or de-fogging methods are well known from automotive fields. For example, heated wires may be placed in zones where de-icing, de-fogging is needed/required. It is known also heated coating to defrost automotive glazing However, all these methods are presenting drawbacks. For example, they may be not enough efficient in the desired areas, conduct to inhomogeneous heating, lead to some overheating of the glazing or mask (even partially) the necessary vision trough the concerned surface.

Furthermore, automotive windshield de-icing/de-fogging is relatively slow and inefficient. Some of methods used rely upon convection from hot air, which is the result of a number of inefficient conversions starting with engine crank-case heat.

The rear window of vehicles is often defrosted or de-iced with resistive electrical wires which are embedded into the window. This heating methodology is somewhat more direct in that the electrical resistance in the wires causes heat to be conductively transferred to glazing in which they are embedded. This ultimately creates sufficient heat at the outside glass surface to exceed the melting temperature of ice. The warmed windshield conductively heats the ice which has formed on the outside of the window. When enough joules of energy have been absorbed by the ice to reach its transition temperature, the ice will begin to change to liquid water. This is a more direct method of warming the glass to melt and eliminate the ice, but it still requires heating the glass to a temperature that will ultimately melt the ice.

Some automobile manufacturers have tried incorporating the embedded resistive wires in the front windshield. It apparently has not been well accepted by consumers because of the wires which are annoying and distracting in the driver's or sensor's field of view.

One thing that is common to all of the systems described above is that none of them directly inject heat energy into the ice or fog/water at the interface with the surface supporting the ice or water. This is a major cause of inefficiency and it directly slows down the functionality of the de-icing or ice or water releasing systems.

An object of this invention is to provide a direct and efficient way of de-icing or releasing ice or water from a substrate surface. More particularly, an object of this invention is to provide a local and very efficient way of de-icing or releasing ice or fog/water of a zone of a substrate whereon a sensor is provided, more particularly, an infrared-based sensing device in the wavelength range from 750 to 1650 nm is provided or a camera

Another object of this invention is to provide a narrowband irradiation system and method which can melt ice by taking advantage of the absorption peaks of an element or compound from which ice may be formed or the ice itself.

Another object of the present invention is to provide an efficient de-icing or ice releasing system and method which can directly irradiate the interfacial ice on the substrate surface, thus turning it into water to provide easy release for the balance of the thickness of the ice.

In one aspect of the presently described embodiments, a system comprises (a) a substrate material which is highly transmissive at infrared irradiation wavelength(s) which will be employed and on which ice or fog/water has formed, and, (b) irradiation producing devices operative to emit irradiation that passes through at least some portion of the substrate so that a first portion of the ice that is impacted by the irradiation is an interfacial portion nearest a surface of the substrate, the devices being proximate the substrate material, and selectively activated to effect irradiation, causing melting of at least some ice nearest the surface of the substrate.

Thanks to the present invention, the glazing covered by ice may be defrost without overheating the glazing. Only the ice to be defrost is heated. Also, fog or water may be released without overheating the glazing.

In another aspect of the presently described embodiments, the narrowband irradiation devices are at least one of LEDs, LETs, and laser diodes, The narrowband irradiation producing devices are devices allowing to direct the irradiation direct to the zone covered by the ice. Thus, the energy used to defrost (or defog) is well directed to the point to be defrosted and allow to save energy by minimizing even completely eliminate the loss of energy.

In another aspect of the presently described embodiments the narrowband irradiation devices are counted in an array on a planar mounting board.

In another aspect of the presently described embodiments the narrowband irradiation is approximately centered around a wavelength absorption peak in the absorption spectrum of the ice.

In another aspect of the presently described embodiments, a majority of narrowband irradiation energy is contained within a 400 nm range.

In another aspect of the presently described embodiments, majority of the narrowband irradiation energy is contained within a 50 nm range.

In another aspect of the presently described embodiments, the narrowband irradiation devices are laser diodes and the full width half maximum irradiation bandwidth is less than 20 nm.

In another aspect of the presently described embodiments, the narrowband irradiation devices are laser diodes and the full width half maximum irradiation bandwidth is less than 8 nm.

In another aspect of the presently described embodiments, the narrowband irradiation device is comprised of an SE-DFB laser diode and the full width half maximum irradiation bandwidth is less than 2 nm.

In another aspect of the presently described embodiments, the planar mounting board is designed to sink heat away from the irradiation devices mounted thereon.

In another aspect of the presently described embodiments, the narrowband irradiation producing devices are digital semiconductor devices.

In another aspect of the presently described embodiments, the substrate material acts as a light pipe.

In another aspect of the presently described embodiments, the method comprises (a) providing a substrate on which ice is formed to be deiced, (b) positioning narrowband irradiation producing devices such that irradiation will pass through the substrate on which the ice is formed before it strikes the ice, and, (c) irradiating an interfacial layer of the ice through at least some portion of the substrate with narrowband radiant energy.

In another aspect of the presently described embodiments, the narrowband radiant energy is in the infrared wavelength band.

In another aspect of the presently described embodiments, the narrowband radiant energy is applied at a local absorption peak wavelength according to the ice material's absorption spectrum.

In another aspect of the presently described embodiments, the narrowband radiant energy employed is largely contained within a 400 nm bandwidth.

In another aspect of the presently described embodiments, the narrowband radiant energy is largely produced within a 20 nm overall bandwidth.

In another aspect of the presently described embodiments, the narrowband radiant energy is produced by an array of semiconductor devices.

In another aspect of the presently described embodiments, the semiconductor devices are comprised of at least light emitting diodes, light emitting transistors, or laser diodes.

In another aspect of the presently described embodiments, the narrowband radiant energy is produced by surface emitting laser diodes devices.

In another aspect of the presently described embodiments, the narrowband radiant energy which is employed is at approximately one of 1,456 nm, 1,950 nm or 2,400 nm.

In another aspect of the presently described embodiments, the irradiating comprises a pulsing.

In another embodiment of the present invention, the wavelength used to de-ice the substrate is different from the wave length that the captor is using to prevent interferences.

In another aspect of the presently described embodiments, the irradiating results in creating liquid, thermal shock or cracking of the ice.

According to the present invention, the substrate to be defrosted relates to substrate exhibiting high transmission of infrared radiation.

In a preferred embodiment of the present invention, the substrate is a glass sheet or a plastic sheet as such polycarbonate or PMMA exhibiting high transmission of infrared radiation.

For simplicity, the numbering of the glass sheets in the following description refers to the numbering nomenclature conventionally used for glazing. Thus, the face of the glazing in contact with the environment outside the vehicle is known as the side 1 and the surface in contact with the internal medium, that is to say the passenger compartment, is called face 2. For a laminated glazing, the glass or plastic sheet in contact with the outside environment the vehicle is known as the side 1 and the surface in contact with the internal part, namely the passenger compartment, is called face 4.

For avoidance of doubt, the terms “external” and “internal” refer to the orientation of the glass trim element during installation in a vehicle.

Also for avoidance of doubt, the present invention is applicable for all means of transport such as automotive, train, plane . . . but also other vehicles like drones, . . . . The present invention is also applicable to any substrate, particularly a glass or plastic substrate comprising an irradiation producing devices operative to emit irradiation that passes through at least some portion of the substrate that may be de-iced and/or de-fogged.

Thus, the use of substrate exhibiting high transmission of infrared radiation allows:
(i) the injection of infrared (IR) radiation, for example by virtue of LEDs, into a substrate transparent to infrared radiation starting from one or more edges;
(ii) the propagation of the infrared radiation inside the said substrate (which then acts as waveguide) via an optical phenomenon of total internal reflection (no radiation “exits” the substrate);
(iii) the presence of ice or fog on the surface where was the injected IR, resulting in a local perturbation by scattering of the radiation in all directions; some of the deflected rays will thus be able “to exit” the substrate and irradiate the ice with precision.

The deflected rays form an infrared light spot on the lower surface of the substrate, opposite the external surface in contact with ice.

Basically, glass is a material of choice as a result of its mechanical properties, its durability, its resistance to scratching and its optical clarity and because it can be chemically or thermally strengthened.

Thus, a glass sheet highly transparent to infrared radiation is very useful in this context, in order to guarantee an intact or sufficient sensitivity over the entire surface when this surface is large. In particular, the glass sheet has an absorption coefficient lower than 5 m⁻¹ in the wavelength range from 750 to 1650 nm is ideal.

The glass can thus be a soda-lime-silica type glass, alumino-silicate, boro-silicate, . . . .

Preferably, the glass sheet having a high level of near infrared radiation transmission is an extra-clear glass.

Preferably, the base glass composition of the invention comprises a total content expressed in weight percentages of glass:

| | |
|---|---|
| SiO2 | 55-85% |
| Al2O3 | 0-30% |
| B2O3 | 0-20% |
| Na2O | 0-25% |
| CaO | 0-20% |
| MgO | 0-15% |
| K2O | 0-20% |
| BaO | 0-20%. |

More preferably, the base glass composition comprises according to the invention in a content, expressed as total weight of glass percentages:

| | |
|---|---|
| SiO2 | 55-78% |
| Al2O3 | 0-18% |
| B2O3 | 0-18% |
| Na2O | 0-20% |
| CaO | 0-15% |
| MgO | 0-13% |
| K2O | 0-10% |
| BaO | 0-5% |

More preferably, for reasons of lower production costs, the at least one glass sheet according to the invention is made of soda-lime glass. Advantageously, according to this embodiment, the base glass composition comprises a content, expressed as the total weight of glass percentages:

| | |
|---|---|
| SiO2 | 60-75% |
| Al2O3 | 0-6% |
| B2O3 | 0-4% |
| CaO | 0-15% |
| MgO | 0-13% |
| Na2O | 5-20% |
| K2O | 0-10% |
| BaO | 0-5%. |

In addition to its basic composition, the glass may include other components, nature and adapted according to quantity of the desired effect.

A solution proposed in the invention to obtain a very transparent glass in the high infrared (IR), with weak or no impact on its aesthetic or its color, is to combine in the glass composition a low iron quantity and chromium in a range of specific contents.

Thus, according to a first embodiment, the glass sheet preferably has a composition which comprises a content, expressed as the total weight of glass percentages:

| | |
|---|---|
| Fe total (expressed as Fe2O3) | 0.002-0.06% |
| Cr2O3 | 0.0001-0.06%. |

Such glass compositions combining low levels of iron and chromium showed particularly good performance in terms of infrared reflection and show a high transparency in the visible and a little marked tint, near a glass called “extra-clear”. These compositions are described in international applications WO2014128016A1, WO2014180679A1, WO2015011040A1, WO2015011041A1, WO2015011042A1, WO2015011043A1 and WO2015011044A1, incorporated by reference in the present application. According to this first particular embodiment, the composition preferably comprises a chromium content (expressed as Cr2O3) from 0.002 to 0.06% by weight relative to the total weight of the glass. Such contents of chromium it possible to further improve the infrared reflection.

According to a second embodiment, the glass sheet has a composition which comprises a content, expressed as the total weight of glass percentages:

| | |
|---|---|
| Fe total (expressed as Fe2O3) | 0.002-0.06% |
| Cr2O3 | 0.0015-1% |
| Co | 0.0001-1%. |

Such chromium and cobalt based glass compositions showed particularly good performance in terms of infrared reflection while offering interesting possibilities in terms of aesthetics/color (bluish neutrality to intense coloration even up opacity). Such compositions are described in European patent application No. 13 198 454.4, incorporated by reference herein.

According to a third embodiment, the glass sheets have a composition which comprises a content, expressed as the total weight of glass percentages:

| | |
|---|---|
| total iron (expressed as Fe2O3) | 0.02-1% |
| Cr2O3 | 0.002-0.5% |
| Co | 0.0001-0.5%. |

Preferably, according to this embodiment, the composition comprises: 0.06%<Total Iron≤1%.

Such compositions based on chromium and cobalt are used to obtain colored glass sheets in the blue-green range, comparable in terms of color and light transmission with blue and green glasses on the market, but with performances particularly good in terms of infrared transmission. Such compositions are described in European patent application EP15172780.7, and incorporated by reference into the present application.

According to a fourth embodiment, the glass sheet has a composition which comprises a content, expressed as the total weight of glass percentages:

| | |
|---|---|
| total iron (expressed as Fe2O3) | 0.002-1% |
| Cr2O3 | 0.001-0.5% |
| Co | 0.0001-0.5%. |
| Se | 0.0003-0.5%. |

Such glass compositions based on chromium, cobalt and selenium have shown particularly good performance in terms of infrared reflection, while offering interesting possibilities in terms of aesthetics/color (gray neutral to slight staining intense in the gray-bronze range). Such compositions are described in the application of European patent EP15172779.9, and incorporated by reference into the present application.

According to a first alternative embodiment, the glass sheet has a composition which comprises a content, expressed as the total weight of glass percentages:

| | |
|---|---|
| total iron (expressed as Fe2O3) | 0.002-0.06% |
| CeO2 | 0.001-1%. |

Such compositions are described in European patent application No. 13 193 345.9, incorporated by reference herein.

According to another alternative embodiment, the glass has a composition which comprises a content, expressed as the total weight of glass percentages:

| | |
|---|---|
| total iron (expressed as Fe2O3) | 0.002-0.06%; |

and one of the following components:
manganese (calculated as MnO) in an amount ranging from 0.01 to 1% by weight;
antimony (expressed as Sb2O3), in an amount ranging from 0.01 to 1% by weight;
arsenic (expressed as As2O3), in an amount ranging from 0.01 to 1% by weight, or
copper (expressed as CuO), in an amount ranging from 0.0002 to 0.1% by weight.

Such compositions are described in European patent application No. 14 167 942.3, incorporated by reference herein.

According to one embodiment of the present invention, the substrate is an automotive glazing. The glazing may be in the form of planar sheets or may be curved. This is usually the case for automotive glazing as for rear windows, side windows or roofs or especially windshields.

In automotive applications, the presence of high transmission substrate and more particularly a glass sheet in the infrared is not conducive for maintaining thermal comfort when the vehicle is exposed to sunlight. Thus, a proposed means of the invention is to provide a glazing with a high selectivity (TL/TE), preferably with a selectivity greater than 1 or greater than 1.3. Thus, to remain under appropriate conditions of energy transmission and thermal comfort, apart from the already specified elements, the glazing according to the invention comprises means to selectively filtering the infrared from sun radiation.

According to a preferred embodiment of the invention, the substrate is an automotive laminated glazing comprising an exterior and an interior glass sheets laminated with at least one thermoplastic interlayer and wherein the exterior and an interior glass sheets are high level of near infrared radiation transmission glass sheets having an absorption coefficient lower than 5 m-1 in the wavelength range from 750 nm to 1650 nm.

According to one embodiment of the present invention, the glass sheet or more generally the substrate has a value of light transmission lower than the value of infrared transmission. Particularly, according to another embodiment of the present invention, the value of light transmission in the visible range is lower than 10% and the value of near infrared transmission is higher than 50%.

According to the present invention, at least one sensor is provided behind the internal face of the glass sheet.

In a preferred embodiment of the present invention, the sensor is an infrared-based remote sensing device in the wavelength range from 750 to 1650 nm is placed behind the internal face of the glass sheet.

According to one embodiment of the present invention, the infrared-based remote sensing device is a LiDAR. LiDAR sensors are preferably new generation LIDAR based on scanning, rotating, flashing or solid state LiDARs and enabling 3D mapping the surroundings around the vehicle. Thus, the IR based sensor allows to make precise mapping of the surrounding of the vehicle which is used to drive correctly the autonomous car and to prevent any shock with an obstacle. LiDAR (also written Lidar, LIDAR or LADAR) is a technology that measures distance by illuminating a target with a laser light. They are particularly scanning, rotating, flashing or solid state LiDAR. The scanning or rotating LiDARS are using moving-lasers beams while flashing and solid state LiDAR emits light pulses which reflect off objects.

According to one embodiment of the present invention, the substrate is a glass piece constituting an optical cover of the sensor located behind.

According to the present invention, irradiation producing devices operative to emit irradiation that passes through at least some portion of the substrate so that a first portion of the ice that is impacted by the irradiation is an interfacial portion nearest a surface of the substrate, the devices being proximate the substrate material, and selectively activated to effect irradiation, causing melting of at least some ice nearest the surface of the substrate.

According to one embodiment of the present invention, the narrowband irradiation devices are at least one of LEDs, LETs, and laser diodes. As such devices are small enough to be placed near the sensor in order to de-iced/defrost in an efficient and quick way the zone wherein the sensor is placed. For example, the irradiation devices may be added in the bracket supporting the sensor or may be integrated into the support of the sensors and more particularly integrated into the support of the LiDAR sensor.

Thus, the zone wherein the sensor is placed may be de-iced/defrosted independently from the rest of the substrate on which the sensor is provided. The narrowband irradiation producing devices according to the present invention are devices allowing to direct the irradiation direct to the zone covered by the ice. Thus, the energy used to defrost is well directed to the point to be defrosted and allow to save energy by minimizing even completely eliminate the loss of energy.

Furthermore, the zone wherein the sensor is provided may be faster and more efficiently defrosted or de-ice compared to rest of the surface of the substrate.

In another aspect of the presently described embodiments, the invention proposes a method comprising the following steps:

(a) providing a substrate having an exterior surface on which ice has formed to be at least partially deiced, wherein a material comprising the said substrate is highly transmissive at an irradiation wavelength which will be employed and capable of total internal reflection,

(b) close-coupling narrowband irradiation sources to at least one edge of the substrate material to provide a way of efficiently injecting narrowband irradiation at the irradiation wavelength into the substrate item, and,

(c) activating the narrowband irradiation sources to create internal reflection of the irradiation such that the photons only escape the substrate item where the ice provides a path for escape by more closely matching the indexes of refraction of the substrate, thus irradiating the interfacial surface of the ice.

In another aspect of the presently described embodiments, the narrowband irradiation is in the infrared wavelength band.

In another aspect of the presently described embodiments, the narrowband irradiation is applied at a local absorption peak wavelength according to the ice material's absorption spectrum.

In another aspect of the presently described embodiments, the narrowband irradiation is largely contained within a 400 nm bandwidth.

In another aspect of the presently described embodiments, the narrowband irradiation is largely produced within a 20 nm overall bandwidth.

In another aspect of the presently described embodiments, the narrowband irradiation is produced by an array of semiconductor devices.

In another aspect of the presently described embodiments, the semiconductor devices are comprised of at least light emitting diodes, light emitting transistors, or laser diodes.

In another aspect of the presently described embodiments, the narrowband irradiation is produced by surface emitting laser diodes devices.

In another aspect of the presently described embodiments, the irradiation which is employed is at approximately one of 1,456 nm, 1,950 nm or 2,400 nm. More preferably, the irradiation which is employed is 1,456 nm.

In another aspect of the presently described embodiments, the activating comprises a pulsing.

In another aspect of the presently described embodiments, the activating results in creating liquid, a thermal shock or cracking of the ice.

According to the presently described embodiments, the system comprises an irradiation source comprising, in one form, one or more semiconductor, narrowband irradiation devices with a carefully chosen output wavelength. The output wavelength is chosen so that it corresponds to or matches both the absorption peak(s) of ice and/or water (or another frozen substance) and a highly transmissive wavelength of the substrate on which the ice has formed. The array is fundamentally positioned (e.g. the devices are proximate the substrate in a suitable position and configuration) so that it can be selectively activated to irradiate through the transmissive supporting substrate, such that the narrowband output radiation is readily absorbed on the surface of the ice. Thus, the interfacial ice (e.g. the portion of ice nearest the substrate surface on which it rests) is, in one form, the first portion of the ice impacted by the irradiation and is melted into a slippery liquid water. With a melted, thin layer of water between the host substrate and the ice, the ice can be easily separated from the host substrate material. The liquid water interface acts as a lubricant, such that one of many described modalities, and others, can easily remove the ice from the surface. Gravity, wind, wipers, centrifugal force, and many other means can then act upon the ice which may have previously been frozen to the host substrate surface. Also, a material or coating may be added or applied to the substrate surface that will enhance the lubricant function when the ice melts to water, for example, at the interface.

Many types of narrowband irradiation devices can be employed to practice this invention to achieve the desired wavelength of irradiation which, in at least one form, matches a desired absorption characteristic of ice and/or water and a transmissive characteristic of a material upon which the ice or water is supported. In at least some forms, the desired wavelength band is an infrared wavelength band. For example, the narrowband irradiation devices may employ wavelengths of approximately 1456 nm, 1950 nm, or 2400 nm (e.g. ±40 nm), as indicated above. At least some of these devices that can be used in manners according to the presently described embodiments are described in the previously filed patent(s) and patent applications relating to DHI technology noted above.

Certainly LEDs, laser diodes, solid-state lasers, light emitting transistors (LETs), gas lasers, surface emitting laser diodes including SE-DFB (Surface Emitting Distributive Feedback) devices and other narrowband irradiation sources (some of which are referenced herein) would be possible irradiation devices for use with this invention. The semiconductor and solid-state based products indicated above would typically be easier to implement and more compact but any type of narrowband device could be employed if it fit the application well. The same concept applies for melting ice of many different compounds or elements.

The fact that the irradiation energy passes through the transmissive material and is directly absorbed on the surface of the ice and/or water is fundamental to the efficiency of the invention. Excess energy is not, therefore, wasted by heating the substrate on which the ice is forming. Rather, heat or radiation goes straight to the melting of the interfacial ice which then turns to liquid water.

An example would be an automotive windshield which has a relatively small thickness compared to the length and width dimensions. In this case, the use of narrowband irradiation devices according to the present invention could be implemented whereby large arrays could be positioned across the entire windshield to melt the ice on the surface of the windshield, as described thus far. However, by implementing the technology as though the substrate is a light pipe, it is possible to couple the narrowband irradiation devices directly into one of the small dimension sides of the substrate.

Again, using the example of a substrate material in the form of a windshield, the narrowband irradiation device arrays could be coupled to the small dimension, e.g. dimension (e.g., the thickness) of the windshield. A power supply can be connected via connections to generate an output for the arrays. As noted above, a controller (not shown) may also be provided to control the arrays. Because the index of refraction differential is large between the glass 80, which comprises the windshield, and the air, which borders the windshield on both sides, the reflections which occur inside the windshield keep the energy contained within it, as shown by rays 71. When another substance 50, such as the ice or water, is on the surface of the windshield 80, the index of refraction difference between the glass and the water or ice are much closer to one another and the energy can exit into the ice. This technique acts as a selective filter so that energy only exits the windshield through the ice with which it is in contact. Upon exiting into the ice, the radiation is immediately absorbed by the ice, which is highly absorptive at that wavelength. The ice then melts to water at the interface between the ice and surface.

This is thought to be a very efficient way of introducing energy into the substrate from a few smaller point source locations rather than through large arrays spread across the entire surface of, for example, a windshield. Thus, although the ice heating mechanism is similar, it adds the additional sophistication step of turning the substrate into an engineered light pipe.

Alternatively, the narrowband irradiation device arrays could be coupled to at least one of the main surfaces of the windshield by using optical coupling agent such as optical prism or waveguides. The optical prism which be made from glass, plastic or any suitable material is optically coupled to the glass by from example silicon or any suitable material to reflect the irradiation from the irradiation producing devices to the glass or plastic substrate.

Thus, the prism may be placed on a flat surface of the glass or plastic substrate leading optimizing the reflection of the emitted irradiation from the irradiation producing devices. Also, to have a prism on at least one surface of the substrate allows for a certain degree of flexibility to design the final product including the system for initiating a de-icing or defogging according to the present invention.

An advantage of the present invention is the provision of a technology which can be extremely selective and aim-able as it targets specific ice as needed for a particular application. Another advantage of the present invention is the ability to deploy the system in a more optimized way by utilizing the total internal reflection of a light pipe technique whereby the irradiation energy can escape the substrate transmissive material primarily into the ice as the indexes of refraction are more closely matched.

Another advantage of the present invention is fast functionality of the contemplated ice melting and ice release system and method.

Another advantage of the present invention is the ability to employ narrowband semiconductor emitting devices whose wavelength output is optimized for melting ice of a particular type.

Another advantage of the present invention is the ability to use a transmissive substrate of substantial thickness and not require heating the thickness of the substrate—but rather irradiate the ice directly through the substrate.

Another advantage of the present invention is the ability to use a substrate transmissive towards broadband irradiation. This allows a sensor to operate at a specific wavelength which is different from the defrosting narrow band irradiation one without interference between both functions. As an example, the defrosting could operate at approximately 1456 nm, 1950 nm, or 2400 nm (e.g. ±40 nm) while a LiDAR sensor located behind the substrate could operate between 900 and 1100 nm.

1. A system for initiating a de-icing or defogging action on which ice or fog has formed on a substrate material, the system comprising:
(a) a substrate on which ice or fog may form; and,
(b) irradiation producing devices operative to emit irradiation that passes through at least some portion of the substrate so that a first portion of the ice or fog that is impacted by the irradiation is an interfacial portion nearest a surface of the substrate, the devices being proximate the substrate material, and selectively activated to effect irradiation, causing melting of at least some ice nearest the surface of the substrate,
wherein the substrate has an absorption coefficient lower than 15 m⁻¹ in a wavelength range from 750 to 1650 nm.

2: The system of claim 1, wherein the substrate has an absorption coefficient lower than 5 m⁻¹ in the wavelength range from 750 to 1650 nm.

3. The system of claim 1, wherein the substrate has an absorption coefficient lower than 1 m⁻¹ in the wavelength range from 750 to 1650 nm.

4. The system of claim 1, wherein the substrate is a glass sheet or a plastic sheet.

5. The system of claim 4, wherein the substrate is a glass sheet.

6. The system of claim 1, wherein a sensor is provided behind an internal face of the substrate.

7. The system of claim 6, wherein the sensor is an infrared-based remote sensing device in the wavelength range from 750 to 1650 nm.

8. The system of claim 1, wherein the sensor is an infrared-based remote sensing device operating at a different wavelength than a narrowband de-icing irradiation due to the substrate having broadband transparency.

9. The system of claim 1, wherein the irradiation producing devices are semiconductor devices.

10. The system of claim 8, wherein the irradiation devices are at least one of LEDs, LETs, and laser diodes.

11. The system of claim 9, wherein the semiconductor irradiation devices are mounted in an array on a planar mounting board.

12. The system of claim 9, wherein the semiconductor irradiation devices are mounted near the sensors to de-ice or de-fog the zone wherein the sensor is mounted.

13. The system of claim 1, wherein narrowband radiant energy is applied at a local absorption peak wavelength according to the ice or water material's absorption spectrum.

14. The system as of claim 1, wherein the substrate material acts as a light pipe.

15. A method of initiating a deicing or defogging action comprising:
(a) providing a substrate on which ice is formed to be deiced;
(b) positioning narrowband irradiation producing devices such that irradiation will pass through the substrate on which the ice is formed before it strikes the ice; and,
(c) irradiating an interfacial layer of the ice through at least some portion of the substrate with narrowband radiant energy.

16. The method of claim 15, wherein the narrowband radiant energy is in the infrared wavelength band.

17. The method of claim 15, wherein the narrowband radiant energy is applied at a local absorption peak wavelength according to the ice or water material's absorption spectrum.

18. The system of claim 1, wherein ice has formed on the substrate.

19. The system of claim 7, wherein the sensor is a LiDAR sensor.

20. The system of claim 1, wherein the irradiation is largely contained within a 400 nm bandwidth.
